(19) United States
(12) Patent Application Publication
(10) Pub. No.: US 2025/0299256 A1
(43) Pub. Date: Sep. 25, 2025

(54) Process of Evaluation Index Creation

(71) Applicant: Anand Rathi Wealth Limited, Mumbai (IN)

(72) Inventors: Feroze Azeez, Mumbai (IN); Shweta Rajani, Mumbai (IN); Kalpesh Koradia, Mumbai (IN); Shivam Pandey, Mumbai (IN); Rinal Dhorda, Mumbai (IN)

(21) Appl. No.: 19/087,395

(22) Filed: Mar. 21, 2025

(30) Foreign Application Priority Data
Mar. 23, 2024 (IN) 202421022738

(51) Int. Cl. G06Q 40/04

(52) U.S. Cl. CPC G06Q 40/04

(57) ABSTRACT

A process of evaluation index (100) creation for organizations, comprising intellectual assets (150), published capital values (110) and indirect values (180) of each organization, the process includes obtaining unorganized information (202) gathered by surrounding information capturing devices, converting unorganized information (202) into organized data (204), calculating asset segment wise projected impact factor (PIF (154)) as a cognitive output (208), calculating evaluation index (100) of each prescribed organization by combining projected impact factors with a base evaluation index (102) of published capital values (110), the projected impact factor assessed for validity of the cognitive output (208) and for machine learning algorithm (220), the evaluation index (100) dynamically projects gross national valuation, wherein the converting of unorganized information (202) into organized data (204) is a continuous, generative and re-generative cognitive process based on unfiltered inputs from a plurality of public devices including SIRI, Alexa, read,ai, Gemini.

### CLAIM OF PRIORITY

This application claims priority to Indian Provisional Patent Application No. 202421022738 filed on 23 Mar. 2024, titled “Process of Evaluation Index Creation”.

### FIELD OF THE INVENTION

The present invention relates to a process of Index Creation. Particularly, the invention relates to short listing of Index constituents and their weightage by total market capitalization. More particularly, the invention relates to rebalancing and review of the index to invest.

### BACKGROUND OF THE INVENTION

Stock exchange is a centralized location where many traders, brokers, fund managers and sellers buy or sell shares. Many large companies have their stocks which are listed in India's stock exchange and actively traded. Such stock exchanges in India traded through NSE (National Stock Exchange), BSE (Bombay Stock Exchange) as well as other stock exchange accessed through Bloomberg. The index is a statistical source that indicates performance of a market segment or market trends. Share market index can be built by using range of the variables, including industry, segment, or market capitalization which can be widely used by financial institutions and investors.

US 2017/0018033 A1 provides a method and a system for predicting Stock fluctuation prediction. A system for predicting Stock fluctuation is predicted by a server which includes data collector and a preprocessor collecting news and KOSPI (Korea composite Stock Price Index) data and extracting words from the collected news through stop word removal and morphologic analysis.

Indian patent having application no. 202111005440 provides data processing system and method of avoiding loss in stock exchange platforms. The invention involves favorable stock prices for buying or selling of shares for more profit. This data processing system checks for price comparison to buy and sell at different stock exchange format and reduce the risks associated with making investments in stock exchange. It especially considers difference between share values to compare on NSE and BSE.

The general process for index involves the two-step process to make stock market trading. Firstly, creating of an eligible universe by considering the factors like criterion for minimum free float, or a minimum number of days for which the stock traded on exchange, impact cost, whether stocks are available in Futures & option segment etc. Secondly, from the eligible universe, for index creation or selection of companies and their weights, the index applies filters like free float market cap, average daily turnover, liquidity factors

The earlier processes do not create an index for stock exchange market. Therefore, it is desirable to create the indices extensively which focus on the total market capitalization for the selection of companies and their weights with minimal filters for investment.

Importantly, though different countries and stock exchanges list largely different companies, impact of different stock exchanges on one another is acknowledged yet not quantified. There is clearly a need to bridge this gap on the principles of “Vasudev Kutumbakam” or globalization.

Equally importantly, intellectual capital of companies are arguably acknowledged as an indicator of future and long-term growth, however they are not generally appropriately factored in value assessments. The present invention may be an opportunity to capture this hitherto ignored aspect, particularly with onset of artificial intelligence in the larger future picture.

Lastly, objective decision making in any field needs statical aid and the present invention aims high to be of value addition in yet un-assess-able matters by including and deploying contemporary artificial intelligence.

### OBJECT OF THE INVENTION

To invent a process of index creation in stock exchange market.

To invent a process of global index creation for stock exchange market.

To invent a generic index creation for assessment, evaluation and decision making.

To invent a process of including indirect impact of global scenarios.

To invent a process that includes potential of growth based on human and intelligence resource.

To invent a process of index creation which is capable to identify large in terms of total market capitalization.

To invent a process of index creation which enable to understand broader universe available for constituent of the index.

To invent a process of index creation which is capable to determine weightage of constituents by computing free float market cap.

To invent a process of index creation which allows the review and rebalancing of index constituents to balance weights for better representation of large caps.

To invent a process of index creation which has capability to create a relevant benchmark for fund managers to select a constituent out of similar universe

Another object of a process of index creation is to provide a system for investors and financial institutions with predictions of stock market trends.

Yet another object of the present invention is to invent a process of index creation which effectively identify the proposed investment.

Further another object is to invent an index which can be used as an underlying for implementing various index based derivative strategies.

### SUMMARY OF THE INVENTION

The present invention is an artificial intelligence-based process of creating a global and national evaluation index for a company, which reflects a comprehensive techno-commercial asset valuation of a company. A significant contributor to the evaluation index as per present invention is the published capital and financial values, however not limited thereto. The asset valuation as per the present invention is a step towards appropriately projecting gross national asset valuation, which is particularly significant in the backdrop of India being a developed nation.

Intellectual assets include human resources valuation including but not limited to qualifications and age of the employees and associates. Intellectual assets also include intellectual property, goodwill and heritage values. Intellectual assets also include valuation of all registered as well as unregistered industrial inventive and creative intellectual property.

Each of the intellectual asset is estimated through machine learning of organized data extracted from formal and casual conversations of relevant people, related published printed and media information.

For each of the intellectual asset, a projected impact factor is generated which is superimposed on a projected commercial performance indicator.

Illustratively, a confectionary company say Parle G, invents a new nitrogen packaging by which their biscuits stay crispier and fresh and withstand higher jerks in transportation. A patent obtained for this technical advance would enable an additional customer base, including a global base. Consequently, a projected contribution value is worked out.

Intelligent indirect value creators include individual organisations' steps to integrate their learnings and convert them into resources for quantifiable deliverables. A significant illustration is around Succession Planning of leadership.

A succession plan is a proactive strategy that organizations use to ensure the continuity of leadership and key functions in the event of planned or unexpected departures of employees in critical roles. It involves identifying and grooming individuals within the organization or external candidates to assume these roles, ensuring minimal disruption to operations and strategic objectives.

When an organization has a robust policy of succession planning, the gross national valuation or organizational performance follows a predictable, as shown by a dotted line, or better than predictable path, as shown by a line of higher slope than prior to a planned successor taking over. Succession is not an overnight passing of baton. A structured overlap of several years with respect to current leadership meaningfully picks up domain knowledge of business operations to be able to seamlessly carry forward and deliver as per projected asking rate commensurate with the Industry. Such succession overlap is comparable to “Yuvraj” position in heritage India.

An absence of succession planning generally causes an unpredictable gross national valuation dip or performance dip. The performance dip is generally indirect including a loss of trust, but it would snowball to a direct hit to a company. Ironically, a large number of companies are gripped in clutches of continuing leadership and a succession is seen as a threat of loss of power and control by most leaders and succession is either disheartenedly done or not done at all. Most companies may recover from consequential performance dip, but it is maturely avoidable.

Geometrically changing operational scenario over currently intense technology based operations management poses newer leadership challenges faster than an aging leader can learn. With passing years and time, the skill set starts falling short of unstoppable technological upgradations. Such challenges of the current time are convertible to opportunity by a synchronous change in leadership. Such a change brings a succession boost, and all disadvantages melt away. Skill rotation, matrix leadership are other examples of intelligent indirect value creation tools.

Indirect values include invisible linkages between different stock exchanges of the world. By deploying machine learning, such indirect values are converted to trained models deployable on an artificial intelligent system, which constantly learns and improves with time.

Information and data for intellectual assets and intelligent indirect values is scattered within and outside any organization, homes, restaurants; in verbal, informal communication, besides written informal communication. Tools like Alexa, read.ai, Siri, Gemini collate such information as unorganized information. Such data is converted into organized data to be processed by a machine learning algorithm through a computing and programming hardware deploying the projected impact factor. A cognitive output, thus obtained may be acceptable or may not be acceptable, and therefore either applied or discarded nevertheless fed to machine learning algorithms for continuous improvement in succeeding cognitive output.

A tabulation of companies listed in stock exchanges is used as a base tabulation to further populate the projected impact factors, illustratively PIF ONE, PIF TWO, PIF THREE, PIF FOUR, etc. of such listed companies and applying such factor in Evaluation index, elaborated below with respect to well-known, deployable, historical as well as on-line organized stock exchange data of listed companies.

Thus, the projected impact factors are quantification of innovative initiatives and are therefore ever growing in a social scenario. Several listed organizations across the world are unable to effectively exploit all potential of its resources and the present invention deploying scattered minds and technologically converting it into business strategies is the concept of the present invention facilitating full steamed performance of any company, adding true value in nations economic growth.

Illustrative unorganized information includes
Collection of information related to all wasteful activities in any organization and converting such waste into productive alternative.
Collecting radical and apparently non-implementable growth thoughts at non-recognizable levels in any organization, which get filtered and discarded as waste or MUDA.

The present invention reduces dependence on organized brainstorming which cannot be more than a fraction of a percent of a company's resource in terms of cumulative planned meeting times. The present invention prepares such data and augments a company's index which is otherwise only based on its visible performance and published plans.

The present invention develops a base process of base index creation from stock exchange which has capability to create the benchmark for investors to select a high value and consistent company. Inputs of intellectual asset and intelligent indirect values are superimposed thereon, by a GUI configured to augment the below created index with projected impact factor. Essentially

Evaluation index=function.(PIF ONE, PIF TWO, PIF THREE, PIF FOUR). base evaluation index

Implying that evaluation index as per present invention is a scalar product of base index and a function of PIFs, which regenerate and continuously regenerate due to machine learning by a neural network.

This embodiment described below refers to India, but the invention is not limited thereto.

The base process of base index creation includes three main major steps as below:
1. Defining the constituent of the Index.
2. Determining Weightage of the Index
3. Rebalancing and Review of the Index

The entire inventive process is iterative, with continuous improvement as a core objective. As new data becomes available or as market conditions change, the hypotheses are revisited, and the entire methodology is re-applied. This ongoing process ensures that the AR Index remains adaptable and aligned with evolving market dynamics. By regularly testing new hypotheses and incorporating the latest data, the AR Index can continuously improve, maintaining its relevance and performance in a constantly changing financial landscape.

Such computer implemented gross relative national evaluation is an unorthodox invention of economic significance conforming to patentability laws, particularly of India, USA, Japan and China.

### BRIEF DESCRIPTION OF DRAWINGS

FIG. 1 is a block diagram of elements of Evaluation Index as per present invention.

FIG. 2 is a graphical representation of projected impact factors of intellectual assets.

FIG. 3 is a bar graph of financial numerics and enhanced numerics.

FIG. 4-6 is a line graph of impact of succession planning.

FIG. 7 is a flow diagram of computer implementation of the present invention.

FIG. 8 is an illustrative tabulation of projected impact factors of intellectual assets and indirect values.

FIG. 9 is a block diagram of elements of base evaluation index.

FIG. 10-11 are screen shots related to stock/ISIN validation.

FIG. 12 is a screen shot related to automated stock ranking.

FIG. 13 is tabulation of calculation of IWF.

FIG. 14 is tabulation of 6 months average of stocks.

FIG. 15-18 is tabulation of mother and child AR indices.

FIG. 19 is significant blocks of weightage calculation.

FIG. 20 is steps diagram of rebalancing and recalibration related calculations.

FIG. 21 is step diagram of momentum and volatility calculation.

FIG. 22 is bubble diagram of disaster recovery plan.

### DETAILED DESCRIPTION OF INVENTION

The present invention shall now be described with the help of drawings. The description is illustrative, and the concept is ever growing, therefore the description should not be construed to limit the invention in any manner whatsoever.

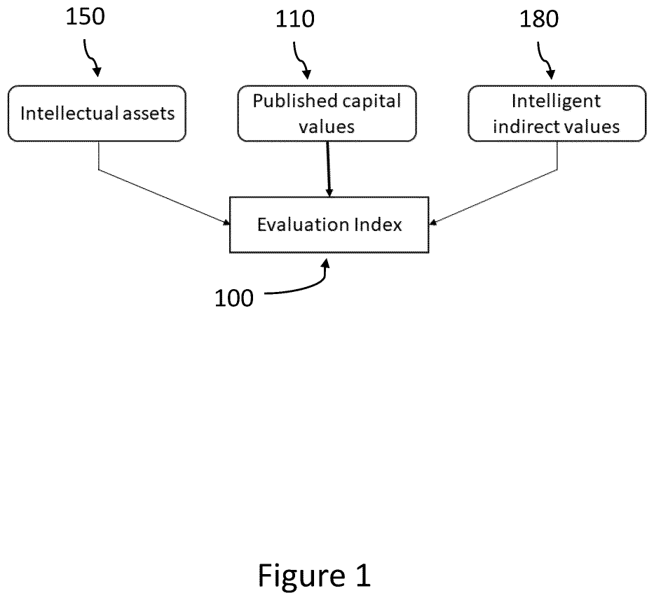

FIG. 1, the present invention is an artificial intelligence-based process of creating a global and national evaluation index (100) for a company (119), which reflects a comprehensive techno-commercial asset valuation of a company (119). A significant contributor to the evaluation index (100) as per present invention is the published capital and financial values (110), and which are explained in detail with illustration of Indian stock exchange related data, however not limited thereto. The asset valuation as per the present invention is a step towards appropriately projecting gross national asset valuation (101), which is particularly significant in the backdrop of India being a developed nation.

Intellectual assets (150) include human resources valuation including but not limited to qualifications and age of the employees and associates. Intellectual assets (150) also include intellectual property, goodwill and heritage values. Intellectual assets (150) also include valuation of all registered as well as unregistered industrial inventive and creative intellectual property.

Intellectual assets (150) of a company (119) include

### 1. Knowledge and Expertise

Knowledge and expertise represent the unique skills, methods, and insights developed over time by individuals or organizations. These include proprietary frameworks, creative recipes, or efficient project management techniques that provide a competitive edge and drive innovation.

### 2. Relationships and Networks

Relationships and networks are valuable connections with stakeholders, suppliers, and partners that foster collaboration and trust. They help secure long-term contracts, enhance market influence, and create strategic advantages in competitive industries.

### 3. Brand and Reputation

A strong brand and positive reputation signify trust, reliability, and market leadership. Companies (119) like Tesla and Disney leverage their brand identities to build customer loyalty and attract top talent and investments.

### 4. Digital and Data Assets

Digital and data assets include algorithms, databases, and analytics tools that drive personalized services and strategic decision-making. These assets, such as Netflix's recommendation algorithm, enhance customer experience and operational efficiency.

### 5. Technological Resources

Technological resources encompass proprietary innovations, platforms, and tools that solve complex problems. Examples include Google's search algorithm and Microsoft's Azure cloud platform, which create market dominance and value.

### 6. Market Intelligence

Market intelligence refers to actionable insights into consumer behaviour, competitive strategies, and technology trends. These insights enable businesses to adapt effectively to market demands and seize opportunities.

### 7. Creative and Artistic Assets

Creative and artistic assets include original works such as storyboards, designs, and portfolios that embody artistic vision and talent. These assets, like Pixar's storyboards, contribute to cultural impact and commercial success.

### 8. Licenses and Agreements

Licenses and agreements provide legal rights to use intellectual properties or operate under established brands. They include franchise agreements, merchandise rights, and software licenses, enabling global reach and operational consistency.

### 9. Organizational Heritage

Organizational heritage captures the legacy and historical significance of an entity, such as iconic projects or contributions to industries. This heritage builds trust and enhances the organization's prestige and market positioning.

Each of the above non-exhaustively illustrative intellectual asset is estimated through machine learning of organized data (204) extracted from formal and casual conversations of relevant people, related published printed and media information.

For each of the intellectual asset, a projected impact factor is generated which is superimposed on a projected commercial performance indicator.

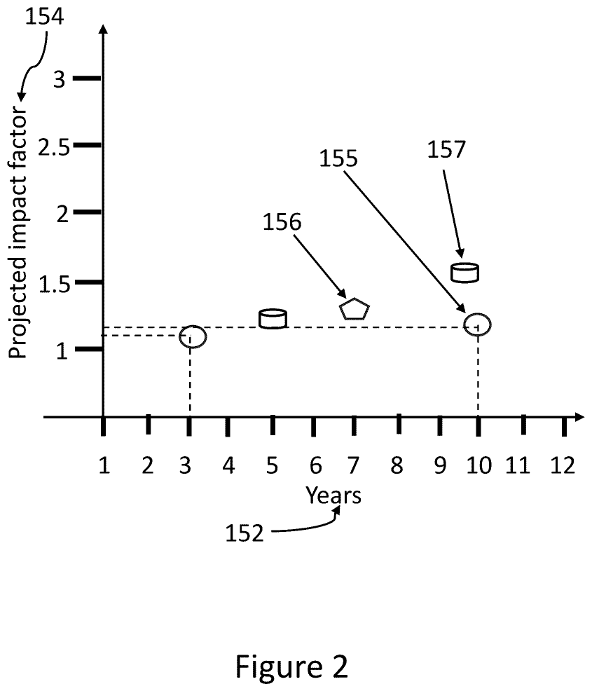

FIG. 2, for example—X-axis indicates year and Y-axis indicates a projected impact factor consequent to companies (119) active patents, professional maturity of human resources, new product stability etc.

So, a circle (155) indicates a strong patent getting granted in year 3 and year 10, resulting in a projected impact factor (PIF (154)) of 1.1 and 1.15 respectively. Such a factor is worked out by assessing its technical advance and economic significance in catering to inventive product augmenting a company's (119) existing product range or opening a new opportunity in technology, and services like cost effective and efficient manufacturing processes. It is essentially a technical projection done by persons skilled in the related technology of product or process or both.

Illustratively, a confectionary company (119) say Parle G, invents a new nitrogen packaging by which their biscuits stay crispier and fresh and withstand higher jerks in transportation. A patent obtained for this technical advance would enable an additional customer base, including a global base.

Likewise, in FIG. 2,
A pentagon (156) indicates employment of a research scientist in the organization who is likely to bring technological edge to the company's (119) portfolio.
A plurality of cylinders (157) indicate technological initiatives which are regularly taken by a company (119) and eventually add to intellectual assets (150) of the company (119).

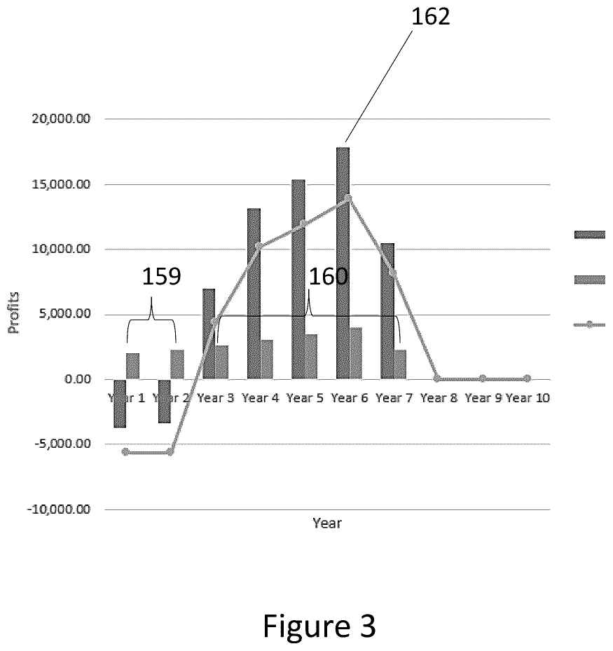

Consequently, a projected contribution value is worked out. FIG. 3 illustratively, yellow bars indicate a published financial numeric (159) of previous two years and projected financial numeric (160) for next few years, while red bars indicate a projected enhanced numeric (162) which is published or projected financial numeric multiplied by a corresponding projected impact factor (PIF)(154) obtained for respective intellectual asset or intelligent indirect value creator.

Intelligent indirect value creators include individual organisations' steps to integrate their learnings and convert them into resources for quantifiable deliverables. A significant illustration is around Succession Planning of leadership.

A succession plan is a proactive strategy that organizations use to ensure the continuity of leadership and key functions in the event of planned or unexpected departures of employees in critical roles. It involves identifying and grooming individuals within the organization or external candidates to assume these roles, ensuring minimal disruption to operations and strategic objectives.

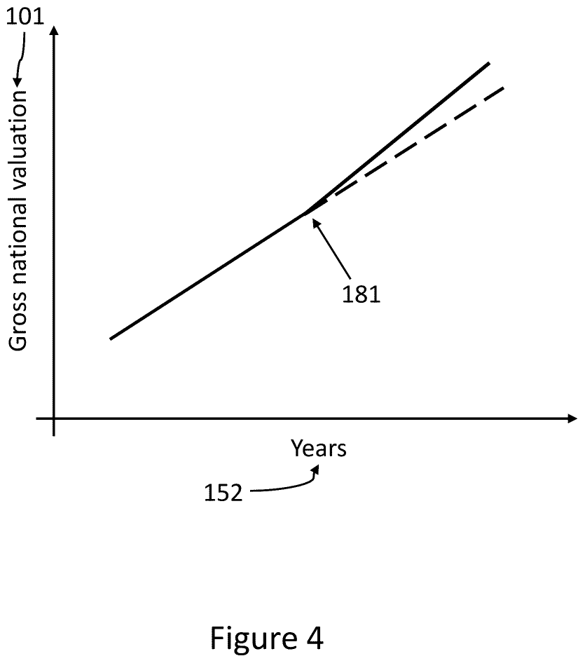

FIG. 4, when an organization has a robust policy of succession planning, the gross national valuation (101) or organizational performance follows a predictable, as shown by a dotted line, or better than predictable path, as shown by a line of higher slope than prior to a planned successor taking over point (181). Succession is not an overnight passing of baton. A structured overlap of several years with respect to current leadership meaningfully picks up domain knowledge of business operations to be able to seamlessly carry forward and deliver as per projected asking rate commensurate with the Industry. Such succession overlap is comparable to “Yuvraj” position in heritage India.

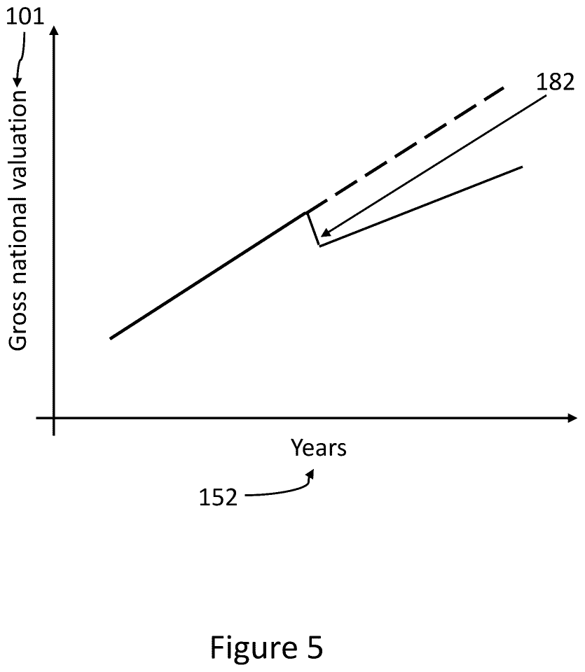

FIG. 5, an absence of succession planning generally causes an unpredictable gross national valuation dip (182) or performance dip (182). The performance dip (182) is generally indirect including a loss of trust, but it would snowball to a direct hit to a company (119). Ironically, a large number of companies (119) are gripped in clutches of continuing leadership and a succession is seen as a threat of loss of power and control by most leaders and succession is either disheartenedly done or not done at all. Most companies (119) may recover from consequential performance dip (182), but it is maturely avoidable.

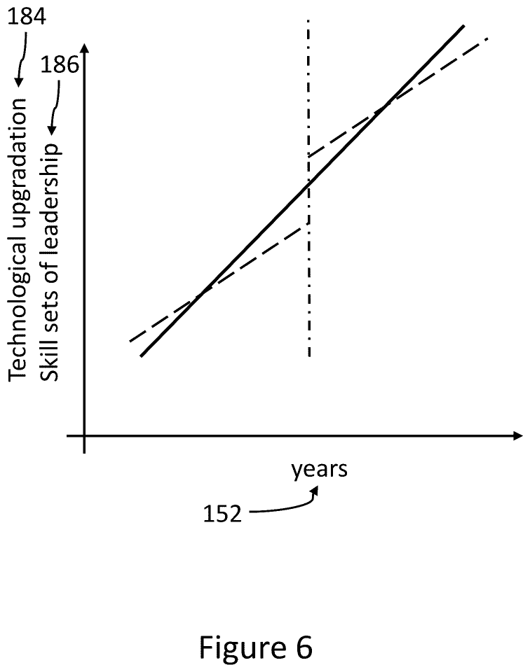

Geometrically changing operational scenarios over currently intense technology based operations management poses newer leadership challenges faster than an aging leader can learn. FIG. 6, solid line represents a continuous technological upgradation (184) in a given society and a lower dotted line represents skill sets of a leader (186) when he or she gets the responsibility. As represented, with passing years and time the skill set starts falling short of unstoppable technological upgradations. Such challenge of the current time are convertible to opportunity by a synchronous change in leadership. Such a change brings a succession boost, and all disadvantages melt away. Skill rotation, matrix leadership are other examples of intelligent indirect value creation tools.

Indirect values (180) include invisible linkages between different stock exchanges of the world. By deploying machine learning, such indirect values (180) are converted to trained models deployable on an artificial intelligent system, which constantly learns and improves with time.

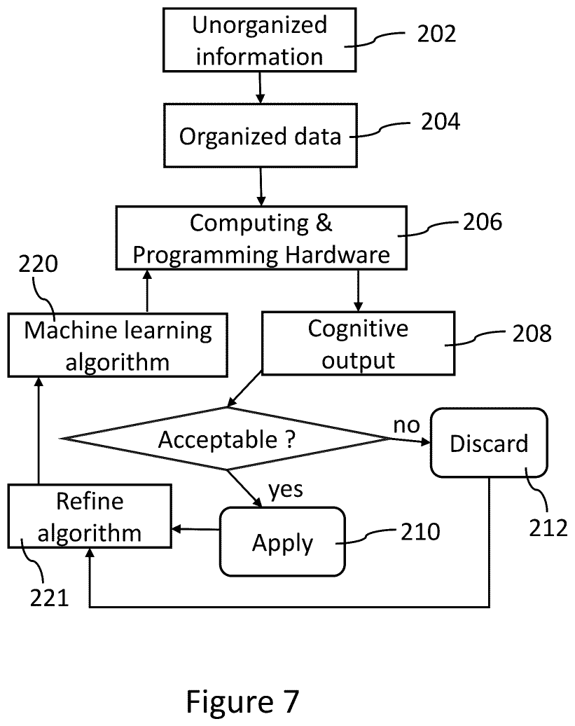

Information and data for intellectual assets (150) and intelligent indirect values (180) is scattered within and outside any organization, homes, restaurants; in verbal, informal communication, besides written informal communication. Tools like Alexa, read.ai, Siri, Gemini collate such information as unorganized information (202). FIG. 7, such data is converted into organized data (204) to be processed by a machine learning algorithm through a computing and programming hardware (206) deploying the projected impact factor. A cognitive output (208), thus obtained may be acceptable or may not be acceptable, and therefore either applied (210) or discarded (212) nevertheless fed to machine learning algorithms (220) after continuous improvement and refinement of algorithm (221) for succeeding cognitive outputs (208).

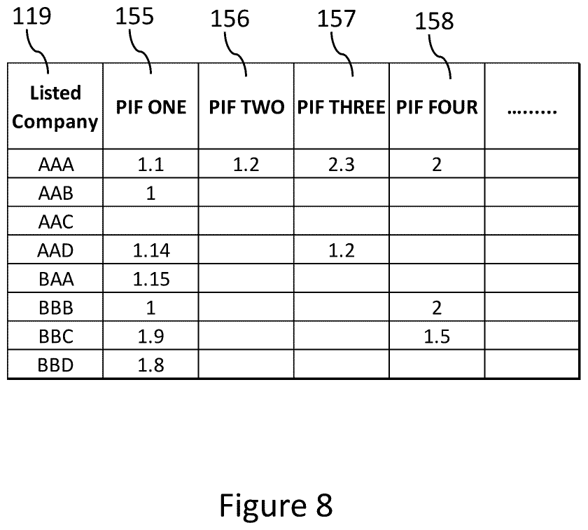

FIG. 8, a tabulation of companies (119) listed in stock exchanges is used as a base tabulation to further populate the projected impact factors, illustratively PIF ONE (155), PIF TWO (156), PIF THREE (157), PIF FOUR (158), etc. of such listed companies (119) and applying such factor in Evaluation index (100), elaborated below with respect to well-known, deployable, historical as well as on-line organized stock exchange data of listed companies (119).

FIG. 7, 8, implies that projected impact factors are quantification of innovative initiatives and are therefore ever growing in a social scenario. Several listed organizations across the world are unable to effectively exploit all potential of its resources and the present invention deploying scattered minds and technologically converting it into business strategies is the concept of the present invention facilitating full steamed performance of any company (119), adding true value in nations economic growth.

Illustrative unorganized information (202) includes
Collection of information related to all wasteful activities in any organization and converting such waste into productive alternative.
Collecting radical and apparently non-implementable growth thoughts at non-recognizable levels in any organization, which get filtered and discarded as waste or MUDA.

The present invention reduces dependence on organized brainstorming which cannot be more than a fraction of a percent of a company's (119) resources in terms of cumulative planned meeting times. The present invention prepares such data and augments a company's (119) index which is otherwise only based on its visible performance and published plans.

The present invention develops a base process of base index creation from stock exchange which has capability to create the benchmark for investors to select a high value and consistent company (119). Inputs of intellectual asset and intelligent indirect values (180) are superimposed thereon, by a GUI configured to augment the below created index with projected impact factor. Essentially

Evaluation index(100)=f(PIF ONE(155), PIF TWO(156), PIF THREE(157), PIF FOUR(158)). base evaluation index(102)

Implying that evaluation index (100) as per present invention is a scalar product of base index (102) and a function of PIFs (154-158), which regenerate and continuously regenerate due to machine learning by a neural network. The computing and programming hardware (206) of configuration

### Core Specifications

1. Processor (CPU):
Intel Core i9-13980HX (1₃th Gen, 24 cores, 5.6 GHz turbo)
AMD Ryzen 9 7945HX (16 cores, 5.4 GHz boost)

2. Graphics (GPU):
NVIDIA GeForce RTX 4090 (16 GB GDDR6)
AMD Radeon RX 7900M

3. RAM:
32 GB DDR5-5600 MHz (Upgradable to 64 GB or 128 GB)

4. Storage:
2 TB NVMe PCle Gen 4 SSD (with extra M.2 slot for expandability)
   or higher caters to the present invention. Importantly, a higher and higher end hardware is deployed to be able to process global unorganized information picked up from every public device including all laptops, work stations and passive devices like Alexa; and a continuously machine learning based algorithm (220).

This embodiment described below refers to India but the invention is not limited thereto.

The base process of base index creation includes three main major steps as below:
1. Defining the constituent (111) of the Index.
2. Determining Weightage (112) of the Index
3. Rebalancing (113) and Review of the Index

Initially, first step of defining the constituent (111) of the Index can be described as:

The companies (119) which have been listed in any stock exchange, particularly of India, would be eligible for selection and shortlisting of the index constituents (111). The process of index creation mainly initializes with understanding the broader universe available for the constituent of such Index. To achieve the same the stocks for companies (119) which are listed as well as actively traded in identified stock exchange, here India's stock exchange, are to be considered. The universe of such stocks which are traded on India's major exchanges, NSE and BSE, as well as other exchanges can be accessed through professional database providers like Bloomberg.

The detailed process of step 1 can be described in the following manner:
a. The universe of all the stocks traded on BSE and NSE is compiled from the Bloomberg using the below steps:
   EQS→Exchanges→Asia Pacific (Emerging)→India→Natl SE of India BSE India
b. A universe of active stock which are active and traded on these two exchanges is thus obtained.

The base process further involves step-2—shortlisting of the universe for the index creation, which is executed by below steps:
a) For the purpose of the computation, first step is to extract the total market cap of each stock on a daily basis for the last 6 months from Bloomberg, by applying the below mentioned formula.

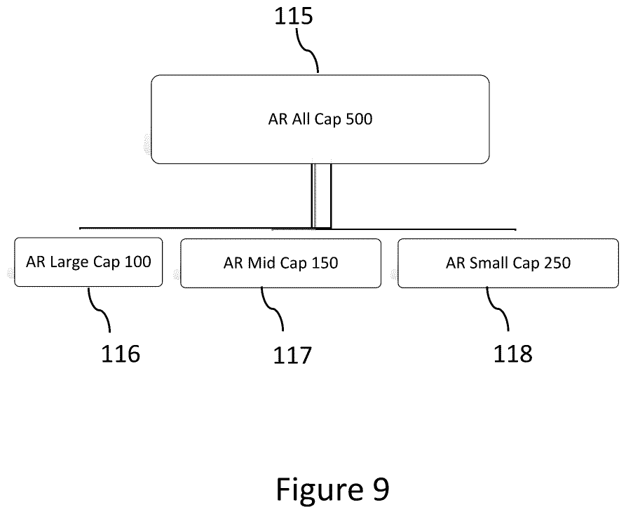

=BDH(“CUR MKT CAP”, Start Date, End Date, $C$4, “dates=h”, “cols=1; rows=124”)
The share prices generally slightly vary between the two exchanges, i.e. BSE and NSE. Therefore, data is to be extracted for both exchanges and afterwards calculation of an average of market capitalization of a particular stock over these two exchanges be made. Consequentially, determination of the average of six-month market capitalization is taken as the reference point for that stock.
   a. A list of average market cap of all listed stocks is sorted in descending order.
   b. A specified number of highest value stocks form a universe of AR All cap index (115), FIG. 9. A preferred specified number is 500. Such universe is also termed as a mother index.
   c. From this mother index, three child indices are obtained and are termed “AR large cap (116)”, “AR Mid cap (117)” and “AR Small cap (118)”.
      i. The first 100 companies (119) are termed as large caps. This serves a universe of large caps.
      ii. Companies (119) ranked 101-250, set of 150 companies (119) are termed as Mid-Caps and form a universe of Mid-Caps.
      iii. Companies (119) ranked 250th and below are termed as small caps, forming a universe of Small-Caps.

Weightages (112) are determined on the basis of free float market cap of a stock. In order to do so, it is needed to extract the free float percentages from the respective constituent (111), which determines the percentage of shares available for trading. Once the free float percentages are obtained, the next step is to multiply free float percentage with total market cap in order to get the free float market cap. Once the data for free float market cap of each company (119) is received, then the sum up for all the constituents (111) of an index is done. Free Float market cap expressed as a percentage of total free float market cap of all the constituents (111) of that index is the weightage (112) of that particular stock in that particular index.

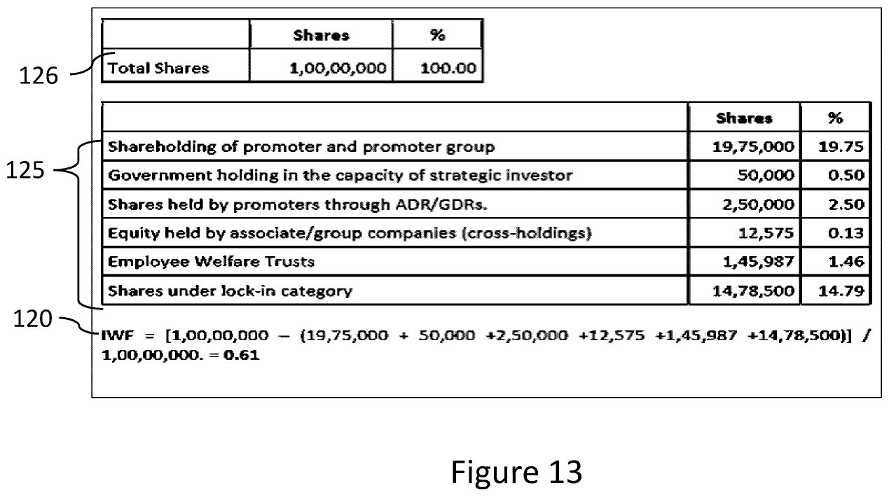

FIG. 13, IWF (120) or “Investible Weight Factor” (120) is the corresponding prevailing term referred to for floating stocks. Refer FIG. 13 for illustration wherein excluded stocks (125) are subtracted from total shares (126) to arrive at the IWF (120).

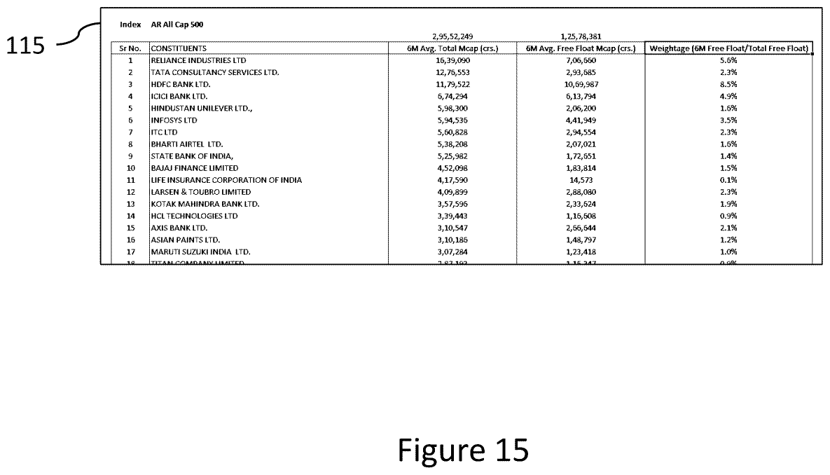

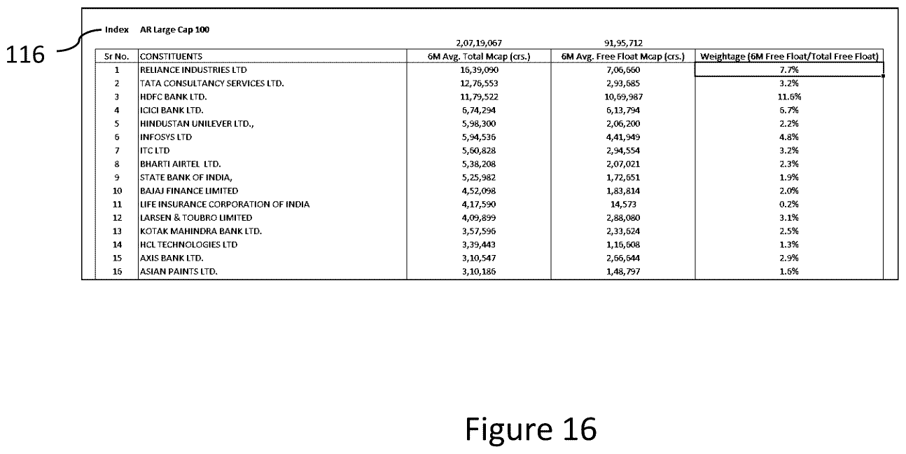

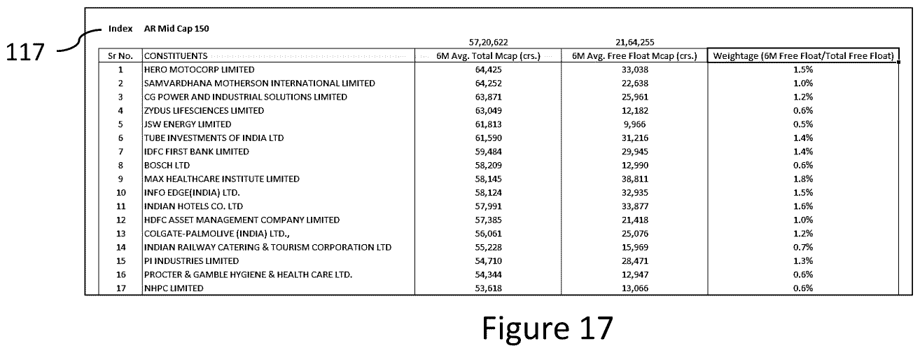

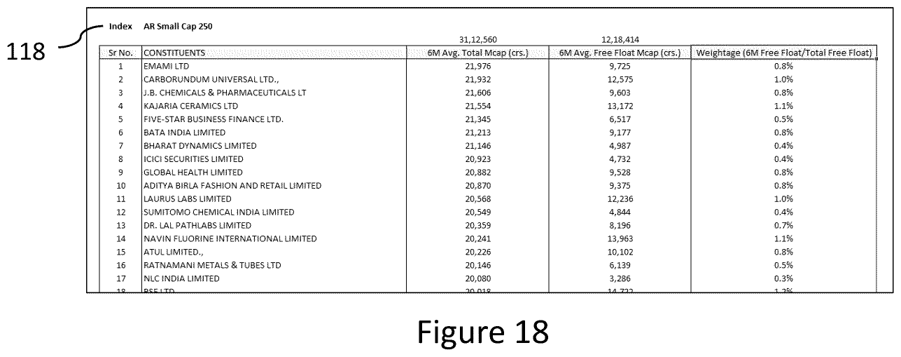

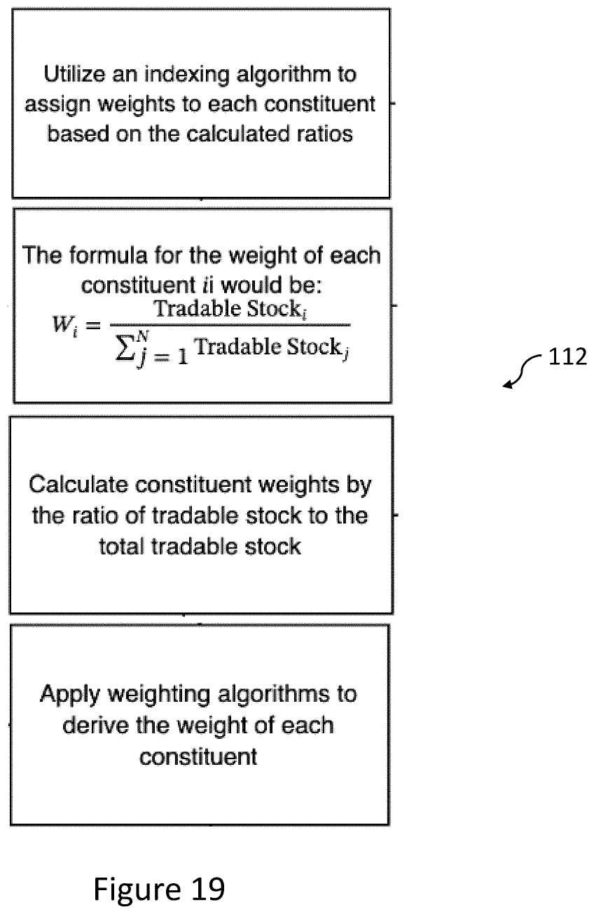

The detailed process of step 2 is stepwise described as below:
a. FIG. 15-18, obtain the constituents (111) of the four AR Indices as follows:
   i. AR All Caps (115) Index: Ranked 1st—500th
   ii. AR Large Cap (116): 1st—100th company (119)
   iii. AR Mid Cap (117): 101st—250th company (119)
   iv. AR Small Cap (118): 251st—500th company (119)
b. FIG. 19, weightage (112) are determined by computing the Free Float market cap of the companies (119) in a particular Index.

$$Weightage ( 112 ) = ( average 6 months Free Float \% * average 6 months Total Market Cap ) / Total free float market cap of all constituents ( 111 )$$

c. Free Float Market cap of companies (119) is computed as:

$$Free Float Market Cap = average 6 months Free Float \% * average 6 months Total Market Cap$$

d. Further, the free float percentage determines number of shares available for trading and which is not held by the entities having strategic interest in a company (119), and is computed as follows:

$$Free Float \% = ( Total Shares outstanding - ( Shareholding of promoter and promoter group + Government holding in the capacity of strategic investor + Shares held by promoters through ADR / GDRs + Equity held by associate / group companies ( 119 ) + Employee Welfare Trusts + Shares un der lock - in category ) ) / Total Shares Outstanding .$$

e. The Free Float % data is extracted, on a daily basis, from the exchange or Bloomberg for the last 6 months using the Bloomberg Extraction Formula:

=BDH(“EQY_FREE_FLOAT_PCT”, Start Date, End Date, $C$4, “dates=h”, “cols=1; rows=124”)
f. An average of these 6 months free float %, is arrived at.
g. Using free float obtained by step c. above, then the average total market cap of each of these stocks is available.
h. Now using the data obtained from step 2.f and 2.g, we can compute the free float market Cap of all the companies (119) in a particular index.

$$Average Free Float Market Cap = average 6 months Free Float \% * average 6 months Total Market Cap$$

i. The next step is to sum up all the constituents (111) free float market cap

=Σ(Free Float Market Cap)_{I} For(I=0 to I=n) where n=no of companies(119) in the index
j. Each stock weight in the particular index is determined by dividing the average free float market cap of the particular index, as obtained in step 2.h, by summing up of all the constituents (111) of free float market cap.

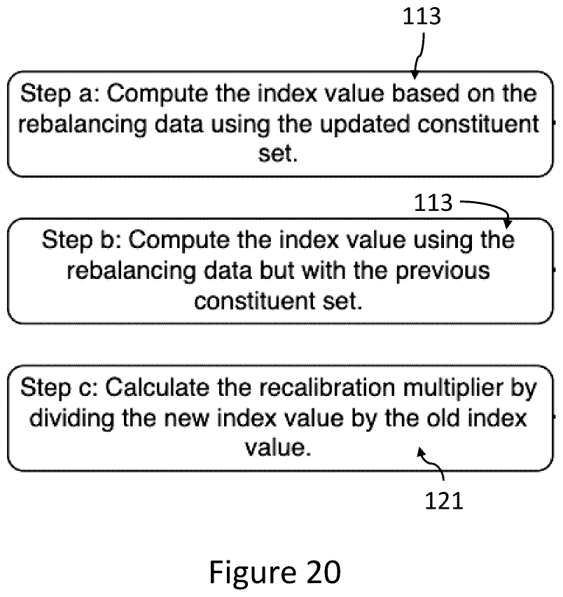

FIG. 20, third step of index creation includes Rebalancing (113) and review of the Index.
a. The index rebalancing (113) frequency would be based on semi-annual basis, which happens at June-end and December-end of the respective Calendar Year.
b. Within 10 calendar days from the end of the 6 months period, the index constituents (111) would be reviewed by following Step 1 and the weights would be rebalanced as per step 2.
c. The rebalancing (113) in any index would be capped to maximum 25% of the companies (119) in any particular index.
d. Within 10 calendar days from the end of the 6 months period, the index constituents (111) would be reviewed by following the process for selection of constituents (111) and the weights would be rebalanced.

The creation of base AR Index solely based on the average six months market capitalization as described above ensures that the base AR Indices accurately reflect the largest companies (119) by market cap without applying additional filters, providing a true representation of a benchmark for the current Mutual Fund industry. When topped up be the intellectual assets (150) valuation and intelligent indirect values (180) as earlier explained, the AR indices become growingly richer in contemporary valuation, constantly deploying machine learning over pure financial numbers.

Following micro-steps describe the technical process deployed towards a robust Evaluation index (100) creation as per the present invention.

Technical process of Data Collection involves accurate and comprehensive market capitalization data for all stocks listed on NSE and BSE. To compile the universe of stocks, the following technical steps are deployed:
1. Data Source Selection: The universe of all actively traded stocks on the National Stock Exchange (NSE) and Bombay Stock Exchange (BSE) is accessed through specialized data retrieval systems.
2. APIs for Data Retrieval: APIs, the application programming interface, including those provided by NSE and BSE or reliable third-party services, are utilized to gather real-time and historical data of all listed stocks. There is no human intervention in such data management, thus delay and errors are ruled out.
3. Comprehensive Data Collection: The APIs fetch data for prescribed stocks that are actively traded on these exchanges. This data is continuously updated to reflect any changes in the list of actively traded stocks.

Market Capitalization Calculation involves following technical process:
1. Automated Data Retrieval: The system being always powered ON, a daily subroutine script automatically retrieves daily market capitalization data for each stock over the past six months via the selected API(s).
2. Data Processing: The retrieved data is processed and converted into a structured format, such as a Data Frame, using data processing libraries like Pandas. The system computes the average market capitalization of six months for each stock, considering any variations between prices on NSE and BSE. If the stock is listed on both the exchanges, the average of market capitalization from both these exchanges will be used and then six months average market capitalization will be calculated.

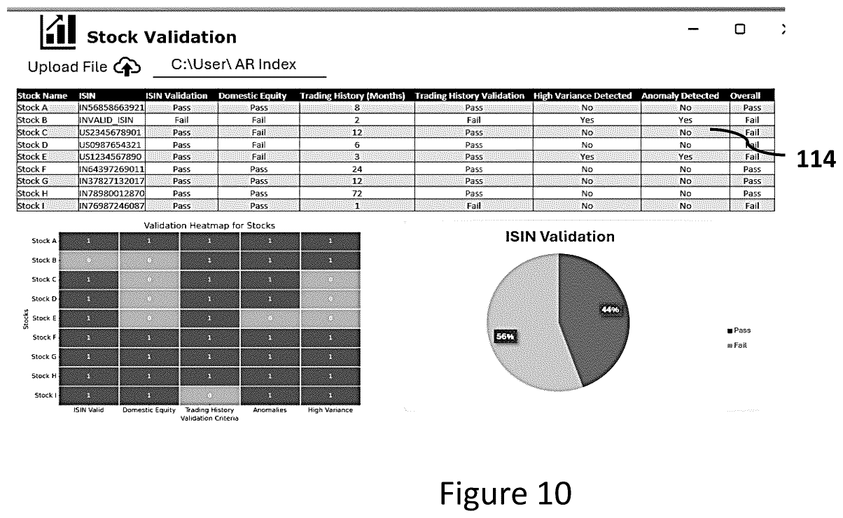

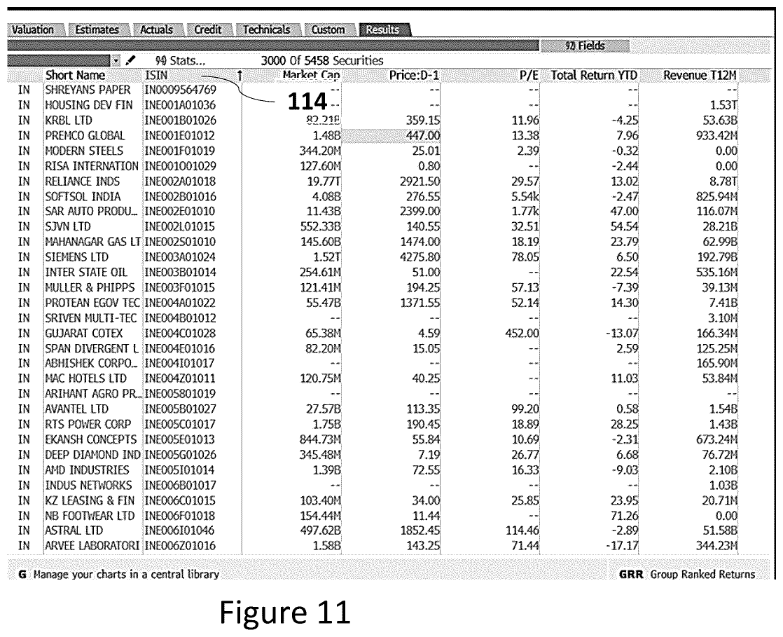

Following error detection techniques are deployed for stock validation (114):
ISIN Validation (114): Regular expressions (regex) and checksum algorithms are used to validate International Securities Identification Numbers (ISINs). This process ensures that each stock's ISIN follows the correct format and is valid, reducing the risk of including incorrect ISINs. Automated tools like Python's module for regex and custom scripts for checksum validation are utilized to streamline this process. FIG. 10, 11.
Trading History Availability: Trading history is verified so that each stock has at least six months of historical data available. For stocks that have launched IPOs within the past six months, availability of minimum three months of trading data is ensured in order to guarantee the reliability of the data used in calculations; automated using data analytics platforms including Python's Pandas library or financial data APIs that can track and report trading histories.
High Variance Detection: The variance in daily market capitalization changes are calculated and stocks with unusually high daily changes identified, potential errors or anomalies investigated to ensure data consistency. Tools including Python's NumPy and pandas libraries, or machine learning models employed to automate the detection and analysis of these variances.
Anomaly Detection: The machine learning algorithms, such as Isolation Forest, One-Class SVM, or Autoencoders, are tailored specifically to identify anomalies in the market capitalization data relevant to the AR Index. For instance, these algorithms are configured to flag stocks with unexpected surges or drops in market capitalization that deviate significantly from historical patterns or sectoral norms. This could include detecting anomalies such as a sudden, unexplained increase in market cap that does not correlate with trading volumes or known corporate actions like dividends or splits. The aim is to ensure that only accurate and reflective data is used for index calculation, thereby maintaining integrity of the AR Index.
Domestic Equities Filtering: Financial data management tools that can automatically classify and filter securities based on predefined criteria deployed to filter out non-domestic equities, rights issues or other non-equity instruments from the dataset. This step ensures that only relevant stocks are considered for AR index creation.

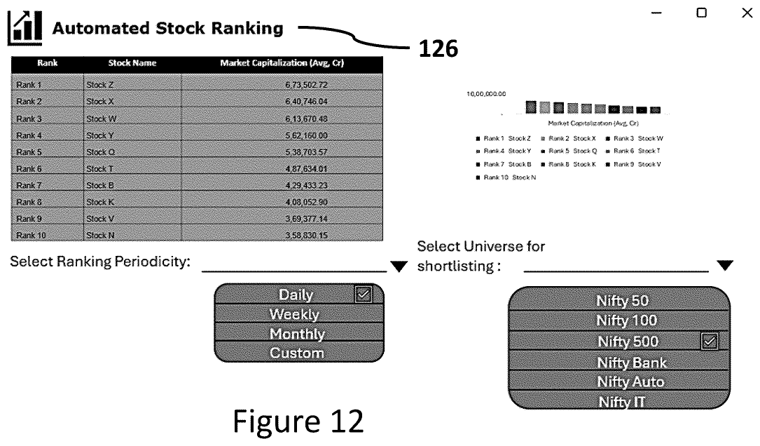

Stock shortlisting—The following steps are deployed to shortlist stocks for the index:
1. Automated Ranking (126): The system will automatically rank stocks according to their average market capitalization over the defined period. This ranking process will be dynamic, continuously updating as new data is retrieved. FIG. 12.
2. Scheduling and Automation: Scheduling tools such as cron jobs or task schedulers will be employed to automate the data retrieval, processing, and ranking processes, ensuring that the shortlisted universe is always based on the most relevant data.

With the objective of Data Storage and Security so as to protect AR Index data efficiently and securely, the technical process comprises the steps of transforming raw data into a structured, efficient format that enhances its usability, storage efficiency, and accessibility for subsequent operations. Data formatting involves cleaning the data, organizing it into standardized structures (e.g., tables, arrays), and ensuring that it is properly indexed. This preparation enables smoother data processing by downstream systems, such as encryption algorithms, security measures, or machine learning models. Data optimization aims to reduce redundancy, minimize storage space, and increase processing speed, particularly when dealing with large datasets, such as those stored in cloud platforms like AWS S3 or Google Cloud.

Technology & Tools deployer are:
AWS S3: We will utilize Amazon Web Services (AWS) Simple Storage Service (S3) for scalable and secure storage. AWS S3 will provide high durability, availability, and scalability for storing large datasets related to AR Index calculations, historical data, and market feeds.
Google Cloud Storage: As an alternative, we may also consider Google Cloud Storage, which will offer similar benefits of scalability, durability, and security.

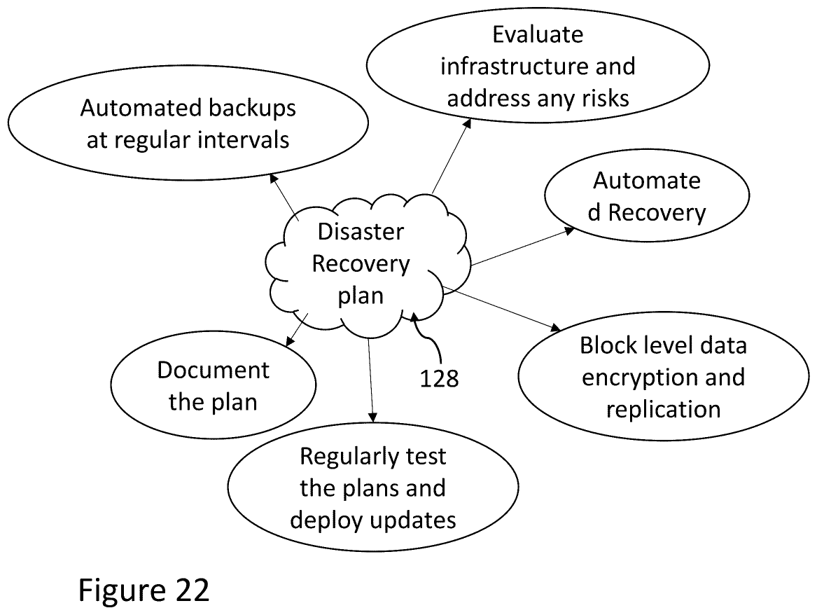

Implementation comprises:
Setting up an AWS S3 bucket or a Google Cloud Storage bucket specifically for storing AR Index data.
Configuring access policies to control who can read or write data, ensuring that only authorized personnel have access.
Using Lifecycle policies to manage the data, such as automatically archiving older data that is no longer actively needed for the AR Index.
Using optimized file formats including Parquet and ORC for AR Index data stored in AWS S3.
When Google Cloud is used, AR Index data to be stored in columnar formats like Avro, which enhances data retrieval speed and reduces storage requirements.
Data normalization techniques applied to remove redundancies, standardize formats (e.g., dates and currencies), and ensure consistency across the AR Index data.
Compression algorithms implemented to reduce the data size, improving network transfer speeds and lowering cloud storage costs.
Data partitioning employed to batch the AR Index data into smaller segments, allowing for parallel processing and faster access across cloud environments.
Using AWS S3 server-side encryption (SSE) to automatically encrypt AR Index data at rest using AES-256 encryption.
When Google Cloud is used, server-side encryption is enabled with Google-managed keys, which will encrypt AR Index data using AES-256 encryption.
Default encryption enabled on the S3 bucket or Google Cloud Storage bucket to protect AR Index data at rest.
Optionally, client-side encryption used to encrypt AR Index data before uploading it to the cloud.
enabling multi-factor authentication (MFA) on AWS accounts to require an additional verification code from a device, such as a smartphone, when accessing AR Index data.
When Google Cloud is used, implement Google Cloud's MFA options to add an extra layer of security to user accounts.
MFA configured in AWS Identity and Access Management (IAM) or Google Cloud Identity.
MFA for all users who have access to sensitive AR Index data, including account credentials and financial models.
Firewalls—AWS Security Groups and Network ACLs: using AWS security groups and network Access Control Lists (ACLs) to control inbound and outbound traffic to the S3 bucket storing AR Index data.
When Google Cloud is used, configure Google Cloud firewalls to manage traffic to and from the storage bucket.
Defining Security groups and ACLs in AWS to allow only trusted IP addresses and block unauthorized access to the AR Index data.
Setting up Firewall rules in Google Cloud to restrict access to the AR Index storage bucket, ensuring that only legitimate traffic is allowed.
utilizing AWS Backup to automate and manage backups of AR Index data stored in S3.
When Google Cloud is used, implementing Google Cloud's backup services to create regular backups and establish a disaster recovery plan (128), FIG. 22.

To ensure data security and compliance:
1. Integrating Data Loss Prevention (DLP) tools, such as Symantec DLP or McAfee Total Protection for DLP, at the data collection stage.
2. Compliance Monitoring, ensuring that all data handling and processing activities comply with relevant regulatory and internal standards.

A process of using advanced data mining techniques to extract ownership patterns for the entire market capitalization universe is inventively deployed, which allows for the identification of relationships and trends that are not easily identifiable through traditional analysis. This approach involves analyzing large datasets of stock ownership information to identify key patterns such as major shareholders, institutional holdings, and distribution trends. Advanced ownership pattern analysis helps detect potential risks, such as ownership concentration in a single entity. If too much ownership is concentrated in one group, it may lead to market manipulation or liquidity risks. By employing advanced data mining to extract ownership patterns, firms can gain a comprehensive view of market capitalization dynamics, improve investment strategies, and minimize risks, creating an inventive edge in portfolio management and market analysis.

To ensure that the index remains relevant an Automated Rebalancing (113) Workflow is set up using tools like Apache Airflow or AWS Step Functions or Cloud Composer to rebalance the indices semi-annually. The workflow follows predefined rules and automatically adjust the index based on the latest data. The system generates a report for manual review, allowing stakeholders to oversee and approve any changes made during the rebalancing (113) process. The system allows for manual overrides, if necessary, while still maintaining an automated backbone for efficiency.

This step involves taking the newly calculated constituent (111) weights and feeding them into the system responsible for calculating the overall market index. The weights represent the proportion of each stock in the index, ensuring that the index reflects the composition and performance of the market or specific sector. For example, after calculating a stock's weight as 15% of the total index, this percentage is integrated into the index system, influencing how much that stock's price movement will affect the index value. The integration of weights is crucial because it ensures that any changes to the underlying stocks are represented in the overall index value.

Rebalancing (113) involves adjusting the stock weights within the index periodically, ensuring the index continues to reflect current market conditions and stock performance. Semi-annual rebalancing (113) means that this process occurs twice a year. A recalibration multiplier (121) is applied during each rebalancing (113) session. This multiplier is derived from the latest known index value and helps adjust the index after changes in the constituent (111) weights. This keeps the index in sync with market movements and any modifications made to the index components.

Example: Let's say the index was at 1,000 points before rebalancing (113), and after rebalancing (113) the constituent (111) stocks, the index would have dropped to 980 points. Applying a recalibration multiplier (121) based on the last known value (1,000) ensures the index doesn't suddenly reflect these changes inaccurately. So, the multiplier would adjust the index back up to align with the prior value and reflect the accurate performance.

Dynamic recalibration refers to the process of automatically adjusting the index values as market conditions change. This is done by using an algorithm that recalibrates the index periodically (e.g., monthly or quarterly).

The algorithm continuously monitors changes in stock prices, market trends, and volatility (124), making real-time adjustments to the index weights. The purpose is to keep the index aligned with the most up-to-date market conditions, ensuring that the index accurately reflects performance at any given moment.

Calculating the Recalibration multiplier (121) involves three key steps that allow for the precise adjustment of the index after changes to the constituent (111) stocks:
Step a: Calculate the index value using the new set of stocks: After changes (such as adding or removing stocks from the index), recalculate the index using the updated set of stocks. This provides a current index value based on the latest data, giving an updated view of the market or sector.
Example: After the inclusion of new stocks and adjusting weights, the recalculated index value might be 1,050.
Step b: Calculate the index value again, using the old set of stocks: With the same data, recalculate the index using the old set of stocks before the changes were made. This establishes a baseline to compare the new index value against.
Example: The old index, before adjustments, might have had a value of 1,000.
Step c: Divide the new index value by the old index value to get the recalibration multiplier (121): To keep the index consistent and prevent significant value fluctuations from skewing performance tracking, the new index value is divided by the old one to calculate a multiplier. This recalibration multiplier (121) is applied to adjust the index back to a consistent baseline while reflecting the changes in the constituent (111) stocks.

Recalibration multiplier (121) ensures the index remains stable and doesn't fluctuate drastically after rebalancing (113). Reflects both historical performance and new adjustments, creating a more accurate picture of market performance. Minimizes sudden jumps or drops in index value, maintaining investor confidence.

Overall, these steps allow for accurate index management, ensuring that the index adapts to market changes while maintaining a smooth and reliable reflection of performance.

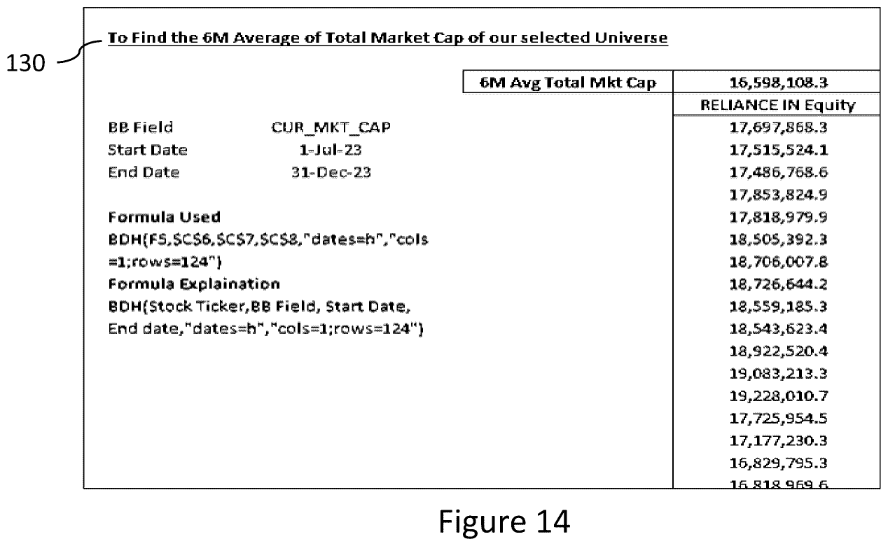

The AR Index with or without augmentation with intellectual asset value and intelligent indirect value is replicable through automated trading algorithms, enabling the creation of index funds and ETFs with minimal manual effort. Automated benchmarking tools allow mutual fund managers to easily compare their performance against the AR Index. The use of real-time data processing solely based on the 6 months average (130), FIG. 14, market capitalization ensures that the AR Indices accurately reflect the largest companies (119) by market cap without applying additional filters, providing a true representation of a benchmark for the Mutual Fund industry. The AR Index can be used as an underlying benchmark for various financial products, including derivatives, structured products, and other financial instruments. This versatility allows for the creation of diverse investment vehicles that can cater to different risk appetites. The use of a six-month averaging period for market capitalization provides a more stable and representative measure of a company's (119) market value. This approach reduces the impact of short-term volatility (124) and potential manipulation, ensuring a more reliable and consistent classification of companies (119) into the respective indices.

This section describes the methodology for constructing and analyzing AR Sub-Indices. The process involves the calculation of various financial metrics, filtering stocks based on predefined criteria, and the formation of sub-indices. The methodology further includes back testing and visualization steps to assess the performance of these sub-indices. The described process leverages machine learning (ML) techniques for enhanced precision in stock selection and weighting.

The initial step involves the acquisition of relevant data points from financial data providers by using APIs. This data includes daily stock prices, P/E ratios, P/B ratios, and other necessary financial metrics. These data points form the foundation for subsequent calculations and analysis.

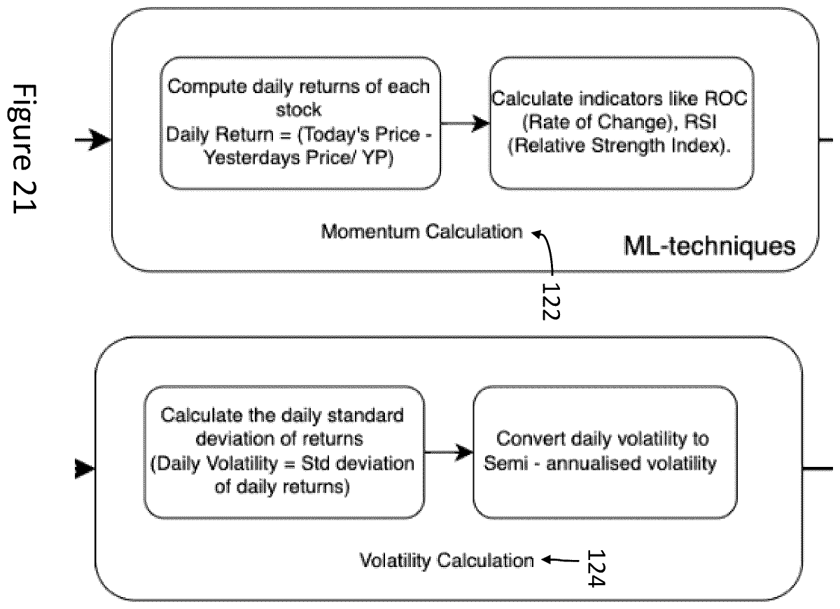

FIG. 21, momentum (122) is a key factor in the construction of AR Momentum (122) Index. The daily returns of each stock are computed. Momentum (122) is derived from these daily returns by summing the returns over a specified period, which could be days, weeks, or months, depending on the analysis horizon.

To accurately calculate momentum (122) indicators such as Rate of Change (ROC) and Relative Strength Index (RSI), a Random Forest Regressor is employed. This technique helps to predict future stock price movements based on historical data, allowing for a more robust calculation of momentum (122). The stocks filtered out using a pre-defined criteria for momentum (122) can then form a part of the AR momentum (122) Index.

Illustratively, for calculating momentum (122) over the last 14 days, instead of simply summing daily returns or calculating percentage changes, the Random Forest Regressor is trained on multiple variables, such as the previous 14-day returns, industry-specific trends, and external market signals.

Based on this training, the model predicts the expected price change for the next period, offering a more forward-looking approach to momentum (122) than a purely backward-looking calculation.

FIG. 21, volatility (124) is a critical factor for AR Volatility (124) Index. Volatility (124) helps to gauge the risk associated with each stock. The standard deviation of daily returns is calculated to quantify the volatility (124) of each stock. This daily volatility (124) is subsequently semi-annualized. The stocks filtered out basis pre-defined criteria(s) for semi annualized volatility (124) can then be a part of the AR volatility (124) index.

Valuation ratios, including P/E and P/B, are collected for each stock. If required, additional metrics like PEG ratios (Price/Earnings to Growth ratio) are computed to assess the valuation of the stocks more comprehensively.

Support Vector Machines (SVMs) are employed here to classify stocks into different valuation bands based on non-linear relationships between the valuation metrics. This technique ensures that the most appropriate stocks are selected based on their valuation profiles. These stocks can then be segregated to form different AR sub-indices basis pre-defined criteria(s) for valuation.

Stocks are filtered individually basis predefined criteria for momentum (122), volatility (124), and valuation respectively. The factors can be combined together to provide a more comprehensive and holistic filtration. For example, stocks with ROC>10%, semi-annualized volatility (124)<20%, and P/E<15 may be selected. These criteria ensure that only stocks meeting specific performance and risk parameters are included in the subsequent steps for sub index creation.

K-means clustering will be utilized to group stocks with similar factor characteristics. This unsupervised learning technique efficiently segments the stock universe, aiding in the accurate filtering of stocks based on the predefined factors.

Filtered stocks are then classified into different sub-indices based on their factor scores, such as AR High Momentum (122) Index, AR Low Volatility (124) Index, AR Value Index, AR Valuation Index. The weight of each stock within its sub-index is determined by the formula. The weighted stocks are incorporated into the index computation framework, where the index value is calculated using a summation of weighted stock prices.

To optimize the weighting scheme, a Neural Network-based optimization algorithm is implemented. This technique fine-tunes the weights of each stock in the sub-indices, ensuring an optimal balance between risk and return.

A model is created to simulate the performance of the sub-indices and gauge future performance of the index. Performance metrics such as returns, and the Sharpe ratio are evaluated to ensure that the constructed indices meet the desired performance standards.

A Monte Carlo simulation is performed during the testing phase to assess the potential variability in returns under different market conditions. This simulation provides a comprehensive understanding of how the sub-indices might perform in the future.

This section presents a comprehensive methodology for enhancing the AR Index by optimizing the weights of its constituents (111). The approach involves the formulation of hypotheses, detailed analysis of various financial and non-financial parameters, and the application of statistical methods and machine learning algorithms (220). This process enables the AR Index to not only dynamically adapt to market trends, but stay ahead of the industry standards, ensuring sustained performance and relevance.

1. Formulation of Hypotheses:

The methodology begins with the formulation of hypotheses aimed at exploring different approaches for determining the optimal weights of index constituents (111). These hypotheses are designed to investigate the potential impact of various parameters on the index's performance. The parameters considered include:
Risk Factors: This includes metrics such as beta, which measures a stock's volatility (124) relative to the market, and Value at Risk (VaR), which estimates the potential loss in value of a portfolio over a defined period for a given confidence interval. Other risk-related measures might involve downside risk and Sharpe ratio.
Liquidity: Parameters under this category include average daily trading volume and bid-ask spreads. High liquidity is essential for ensuring that the index is investable and that trades can be executed without significantly impacting the market price.
Growth Factors: These involve metrics such as revenue growth, earnings growth, and historical earnings per share (EPS) growth. These indicators help assess the future growth potential of the constituents (111), which is a critical factor in determining their weights within the index.
ESG Scores: Environmental, Social, and Governance scores reflect a company (119)'s commitment to socially responsible practices. These scores are increasingly important in modern investment strategies and can influence the weighting of constituents (111) based on their adherence to sustainable practices.
Quality Factors: Metrics such as return on equity (ROE), debt-to-equity ratio, and profit margins fall under this category. These factors help assess the financial health and operational efficiency of the constituents (111), influencing their inclusion and weighting in the index.

Each hypothesis is formulated to test the influence of these parameters individually and in various combinations on the index's performance, with the aim of identifying which factors most significantly contribute to achieving optimal index performance. By testing different parameters (risk, growth, liquidity, etc.), the index is fine-tuned for maximum performance, ensuring the best possible balance between risk and return. In essence, this methodology enables the creation of a dynamic, well-balanced, and performance-driven index that is able to outperform traditional indices by carefully weighing crucial factors that impact both risk and return.

2. Parameter Identification and Combination:

Following hypothesis formulation, the next step is to identify and select the parameters to be tested. This step involves choosing parameters based on their historical relevance, potential predictive power, and their alignment with the overall strategy of the AR Index. Parameters are not only considered individually but also in various combinations to capture potential synergies or interactions that may enhance the index's performance.

For instance, combining risk factors with growth factors could help identify constituents (111) that offer both stability and future potential, thereby optimizing the balance between risk and return. Similarly, integrating ESG scores with quality factors may highlight companies (119) that are not only financially sound but also aligned with sustainable investing principles.

The combinations are carefully designed to capture different market conditions and investment strategies, ensuring that the index can adapt to a wide range of scenarios. Each parameter or combination is rigorously evaluated for its potential impact on the index's overall performance.

3. Data Collection and Preprocessing:

The third step involves comprehensive collection of historical financial and market data for the constituents (111) of the AR Index using APIs. This data includes, but is not limited to:
Stock Prices: Daily, weekly, and monthly price data are gathered to assess price trends, volatility (124), and momentum (122) over time.
Trading Volume: Historical trading volumes provide insights into the liquidity of the stocks and help in understanding market participation.
Financial Ratios: Key financial ratios such as P/E ratios, P/B ratios, ROE, debt-to-equity ratios, and other relevant metrics are collected to evaluate the financial health and performance of the companies (119).
ESG Data: Environmental, Social, and Governance scores are gathered to assess the sustainability practices of the constituents (111).

The preprocessing of this data involves several critical steps to ensure its suitability for analysis. Data normalization and validation steps used in AR index construction are deployed here as well to ensure that the data used is relevant. It also helps to standardize the range of independent variables, allowing for a more meaningful comparison between different parameters. Missing data is addressed through imputation techniques, ensuring that gaps in the dataset do not lead to biased or incomplete analysis. Additionally, variables may be transformed (e.g., logarithmic transformation) to stabilize variance and normalize distributions.

A Big Data framework is leveraged, as this step ensures that the vast amounts of data are efficiently collected, stored, and processed. The use of advanced data management systems enhances scalability, allowing the methodology to handle large datasets with ease and reliability.

Once the data is prepared, regression analysis is performed to explore the relationship between the identified parameters and the index performance. The goal of this analysis is to quantify how much each parameter contributes to the index's performance, thereby providing insights into the relative importance of each factor.

The Linear Regression model is the primary tool used in this analysis. This model helps establish a direct relationship between the dependent variable (index performance) and independent variables (the identified parameters). By analyzing the regression coefficients, we can determine the direction (positive or negative) and magnitude of the impact each parameter has on the index.

However, it is crucial to ensure that the selected parameters are not highly correlated with each other, as this could lead to multicollinearity—where the model becomes unstable, and the estimates of the coefficients are not reliable. To address this, Variance Inflation Factor (VIF) analysis is conducted. VIF quantifies how much the variance of a regression coefficient is inflated due to multicollinearity. A VIF value exceeding a certain threshold indicates a high correlation, prompting the reconsideration of the involved parameters.

This rigorous analysis ensures that the model is both accurate and reliable, providing a solid foundation for the subsequent steps in the methodology.

Following the regression analysis, the coefficients are further scrutinized to assess their significance and impact on the index's performance. This step involves a detailed examination of the statistical significance of each coefficient, helping to determine whether the observed relationships are likely to be real or if they could have occurred by chance.

To assess significance, statistical tests such as the T-test are employed. The T-test evaluates whether the coefficients are significantly different from zero, implying that the parameter has a meaningful impact on the index performance. Additionally, ANOVA (Analysis of Variance) tests are conducted to compare the performance across different groups or combinations of parameters, identifying those that lead to significant improvements in index performance.

This analysis is critical in isolating the most influential parameters, allowing for a focused approach in adjusting the constituent (111) weights within the index.

Based on the results from the previous steps, various index variants are constructed. Each variant represents a different combination of parameter weights, reflecting different strategic approaches (e.g., risk-weighted, growth-oriented, ESG-focused).

To ensure that these index variants are robust and capable of delivering consistent performance, they are subjected to rigorous back testing. Back testing involves applying the index variants to historical data to simulate how they would have performed in the past. This step helps in identifying potential strengths and weaknesses, offering insights into how the index variants might behave under different market conditions.

The performance of each index variant is then compared against a benchmark index. This comparison helps identify the best-performing parameter or combination of parameters. The benchmark could be an industry-standard index, such as the S&P 500, or a custom benchmark designed to reflect specific investment objectives.

Once the best-performing variant is identified, the weights of the constituents (111) within the AR Index are adjusted accordingly. Machine learning algorithms, such as Random Forest, are employed to automate and refine this adjustment process. These algorithms use predictive analytics to anticipate future market trends and make real-time adjustments to the constituent (111) weights, ensuring that the AR Index remains optimized for current and anticipated market conditions.

The entire inventive process is iterative, with continuous improvement as a core objective. As new data becomes available or as market conditions change, the hypotheses are revisited, and the entire methodology is re-applied. This ongoing process ensures that the AR Index remains adaptable and aligned with evolving market dynamics.

By regularly testing new hypotheses and incorporating the latest data, the AR Index can continuously improve, maintaining its relevance and performance in a constantly changing financial landscape.

The process of the present invention inventively deploys information which is largely scattered and unorganized. While large direct financial information data is available in organized form and may be processable using relatively simpler computer tools, indirect and intellectual scattered information around is in the form of continuous including audio data and complex artificial neural network (ANN) including hardware and software, including backpropagation algorithms, descent gradation algorithm are deployed to numerically discretize, use as training data, re-training and self-learning. The present invention being a new concept of evaluation index, available ASICs would need tweaking to effectively organize the hardware, balancing between affordability and implementability of magnitude depending on size and numbers of stock markets and countries.

Such computer implemented gross relative national evaluation is an unorthodox invention of economic significance conforming to patentability laws, particularly of India, USA, Japan and China.

We claim:

1. A process of evaluation index creation for organisations, the evaluation index comprising intellectual assets, published capital values and indirect values of each organisation, the process comprises the steps of:
obtaining unorganized information gathered by surrounding information capturing devices,
converting unorganized information into organized data,
moderating organized data from more than one source,
segregating organized data into intelligent assets and indirect values,
calculating respective projected impact factor (PIF) as a cognitive output of a computer implemented hardware,
calculating evaluation index of each prescribed organisation by combining projected impact factors with a base evaluation index of published capital values,
creating a listing of evaluation index of prescribed organizations in a descending order of their valuation, and
dynamically updating evaluation index and a relative order in the listing;
the projected impact factor (PIF) verified as the cognitive output for machine learning algorithm; the evaluation index dynamically projects gross national valuation.

2. The process of evaluation index creation for organisations as claimed in claim 1, wherein the converting of unorganized information into organized data is a continuous, generative and re-generative cognitive process based on unfiltered inputs from a plurality of public devices including SIRI, Alexa, read,ai, Gemini.

3. The process of evaluation index creation for organisations as claimed in claim 1, wherein the intellectual assets include active patents, significant hiring of human resource, technological upgradation.

4. The process of evaluation index creation for organisations as claimed in claim 1, wherein the indirect values include a succession plan with succession overlap synchronous with technological operational upgradation.

5. The process of evaluation index creation for organisations as claimed in claim 1, wherein the unorganized information includes
information related to all wasteful activities in any organization and converting such waste into productive alternative,
radical and apparently non-implementable growth thoughts at non-recognizable levels in any organization, which get filtered and discarded as waste or MUDA, and or
verbal, informal communication gathered by smart devices including Alexa, read.ai, Siri, Gemini collate such data as unorganized information.

6. The process of evaluation index creation for organisations as claimed in claim 1, wherein the base evaluation index creation of the published capital values comprises the steps of:
a. Compiling a universe of all the stocks traded on a plurality of stock exchanges from a prescribed service provider via application programming interfaces (APIs),
b. Extracting a total market cap of each stock from the plurality of stock exchanges on a daily basis for preceding 6 months from the prescribed service provider via APIs,
c. Calculating an average of all extracted values obtained from the plurality of stock exchanges,
d. Sorting the list of average market cap of all listed stocks in a descending order,
e. Taking a specified number of highest value stocks, termed as a mother index,
f. Obtaining, from the mother index, three child indices termed “AR large cap”, “AR Mid cap” and “AR Small cap”, wherein
i. a first 20% companies form a universe of AR large caps,
ii. a next 30% companies form a universe of AR Mid Caps, and
iii. a next 50% companies form a universe of AR Small Caps,
g. Determining weightages by computing a Free Float market cap of the companies,
h. Determining a free float percentage of number of shares available for trading for each day for a preceding specified period and which are not held by the entities having strategic interest in a company,
i. Computing the free float market Cap of all the companies in respective indices,
j. Summing up the constituent free float market cap,
k. Rebalancing the indices in a prescribed periodicity with an upper limit,
l. Reviewing the indices in a prescribed periodicity.

7. The process of evaluation index creation for organisations as claimed in claim 6, wherein an International Securities Identification Number (ISIN) of each extracted stock is validated through a regular expression (regex) and checksum algorithms.

8. The process of evaluation index creation for organisations as claimed in claim 6, wherein an ownership pattern is extracted and accounted for in indices creation.

9. The process of evaluation index creation for organisations as claimed in claim 6, wherein the rebalancing comprises calculating the index value using the new set of stocks, adjusting the stock weights within the index periodically, ensuring the index continues to reflect current market conditions and stock performance of the old stocks, wherein a recalibration multiplier is applied.

10. The process of evaluation index creation for organisations as claimed in claim 6, wherein an AR momentum index is constructed and accounted for, wherein a Random Forest Regressor is trained on multiple variables including a previous 14-day returns, industry-specific trends, and external market signals.

11. The process of evaluation index creation for organisations as claimed in claim 6, wherein an AR Volatility Index is constructed and accounted for, wherein a semi annualized standard deviation of daily returns is calculated to quantify the volatility of each stock.

12. The process of evaluation index creation for organisations as claimed in claim 6, wherein stocks are classified into different sub-indices based on their factor scores including projected impact factor (PIF), as AR High Momentum Index, AR Low Volatility Index, AR Value Index, AR Valuation Index, the weight of each stock within its sub-index is determined by the formula, the weighted stocks are incorporated into the index computation framework, where the index value is calculated using a summation of weighted stock prices.

13. The process of evaluation index creation for organisations as claimed in claim 1, wherein a Neural Network-based optimization algorithm is implemented, ensuring an optimal balance between risk and return.

14. The process of evaluation index creation for organisations as claimed in claim 6, wherein a hypothesis is formed to assess potential impact of prescribed parameters including liquidity, quality factors, growth factors; wherein each hypothesis is formulated to test the influence of these parameters individually and in various combinations on the index's performance.

15. The process of evaluation index creation for organisations as claimed in claim 6, wherein the process is iterated as new data becomes available or as market conditions change, the hypotheses are revisited, and the entire methodology is re-applied, thereby the AR Index remains adaptable and aligned with evolving market dynamics.
